(19) United States
(12) Patent Application Publication
(10) Pub. No.: US 2007/0223802 A1
(43) Pub. Date: Sep. 27, 2007

(54) INSPECTION APPARATUS, LAMINATION APPARATUS, AND INSPECTION METHOD

(75) Inventor: Hayato Tateda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/457,909

(22) Filed: Jul. 17, 2006

(30) Foreign Application Priority Data
Mar. 23, 2006 (JP) 2006-081672

(51) Int. Cl. G06K 9/00

(52) U.S. Cl. 382/141

(57) ABSTRACT

An inspection apparatus includes an image capturing device for capturing an object's image, and an image data processing device for obtaining a foreign object determination reference value for each piece of partial image data indicating a portion of the object, and detecting a foreign object in the object in the partial image data unit based on the foreign object determination reference value.

### BACKGROUND OF THE INVENTION

1. Field of the Invention

The present invention relates to a defect detecting technology for detecting a defect on an object, and more specifically to an inspection apparatus, a lamination apparatus, and an inspection method for detecting a defect on a prepreg material laminated in a mold by the lamination apparatus.

2. Description of the Related Art

Recently, a number of compound materials using reinforced fiber are applied to sports and leisure products, etc. such as a fishing rod, a golf club shaft, etc. The products are molded by laminating a number of layers of compounds called prepreg obtained by arranging reinforced fiber impregnated with a thermosetting resin and being set afterwards, and then set as molded goods. As the compounds, especially, a prepreg material using carbon fiber have excellent characteristics such as light weight, high rigidity, etc. Therefore, the prepreg material has recently attracted widespread attention as a material for the aircraft and automobile industries, and for other industrial machines.

Generally, when a defect such as a scratch, a straggled portion, a foreign object, etc. is included in laminating prepreg, the above-mentioned characteristic is largely degraded. Therefore, a quality inspection is conducted in a laminating step.

The quality inspection is conducted separately when each affixing step of laminating only one prepreg material is performed, and when the entire process for laminating a predetermined number of prepreg layers is completed. In the inspection in each affixing step, an operator performs a visual check. In the inspection after the entire process is completed, a precise test is conducted by emitting an X-ray, ultrasonics, etc.

A structure molded by laminating prepreg is as small as several meters at most. However, a larger structure has appeared year by year. With a larger structure, there is the stronger probability that a foreign object or other defect can be contained when a prepreg material is layered. On the other hand, a heavier load on an operator is inevitable when an inspection area becomes larger, thereby necessarily increasing the number of operators.

The Japanese Published Patent Application No. H11-1111 discloses a method for automatically making the above-mentioned visual check using a computer. In this method, the quality check can be automatically made by comparing the brightness value of reflected light on the surface of prepreg with a fixed threshold under the situation in which the interior illumination is well managed.

### SUMMARY OF THE INVENTION

The present invention aims at providing an inspection apparatus for automatically detecting a defect in an inspection target range exposed by disturbance light, and includes: for example, an image capturing device for capturing a prepreg object's image, etc.; and an image data processing device for obtaining a defect determination reference value (the defect determination reference value is a predetermined value of, for example, the brightness, the edge strength, etc.) for each piece of partial image data indicating a portion of the object, and detecting the defect on the object in a partial image data unit based on the defect determination reference value.

The present invention also aims at providing a lamination apparatus for automatically detecting a defect in an inspection target range exposed by disturbance light, and the inspection apparatus with the above-mentioned configuration is loaded into the lamination apparatus capable of sequentially laminating a prepreg material while moving on a prepared mold.

The present invention further aims at providing an inspection method for automatically detecting a defect in an inspection target range exposed by disturbance light. In this method, based on the automatic detection of a defect from the image data obtained by image capturing of an object, an average brightness value is calculated in partial image data unit indicating a part of the object, a defect determination reference value corresponding to the average brightness value is extracted from predetermined correspondence information in the partial image data unit, the partial image data is divided using the defect determination reference value as a threshold, and a defect is designated from the divided data.

### BRIEF DESCRIPTION OF THE DRAWINGS

FIGS. 1 and 2 are explanatory views of the method for deriving a foreign object determination reference value for use in the inspection apparatus according to the present invention;

FIG. 3 shows an example of the configuration of the lamination apparatus;

FIG. 4 shows an example of the configuration of an inspection apparatus 14;

FIG. 5 is a timing chart;

FIGS. 6A, 6B, and 6C are explanatory views of the optimum arrangement when an illumination device is used;

FIG. 7 is a graph of the correspondence information generated with the optimum arrangement shown in FIG. 6; and

FIG. 8 is a process flow by a foreign object detection unit 1444.

### DESCRIPTION OF THE PREFERRED EMBODIMENTS

One of the aspect of the inspection apparatus according to the present invention is, for example, a image capturing device for capturing a prepreg object's image, etc.; and an image data processing device for obtaining a defect determination reference value (the defect determination reference value is a predetermined value of, for example, the brightness, the edge strength, etc.) for each piece of partial image data indicating a portion of the object, and detecting the defect on the object in a partial image data unit based on the defect determination reference value.

The above-mentioned image data processing device can also be constituted such that the above-mentioned defect determination reference value can be obtained according to the average brightness value calculated for each piece of the partial image data and the predetermined correspondence information indicating the relationship between the average brightness value and the defect determination reference value variable depending on the average brightness value.

In this case, it is desired that an illumination device for increasing the contrast ratio of the brightness value between the object and the defect is provided so that the correspondence information can indicate the relationship between the average brightness value under the illumination of the illumination device and the defect determination reference value variable depending on the average brightness value.

One of the aspects of the lamination apparatus according to the present invention loads the above-mentioned inspection apparatus in a premise that a prepreg material is sequentially laminated while moving on a prepared mold.

One of the aspect of the inspection method according to the present invention comprises, assuming the case of the automatic detection of a defect from the image data obtained by image capturing of an object, calculating an average brightness value in partial image data unit, extracting a defect determination reference value corresponding to the average brightness value from predetermined correspondence information in the partial image data unit, dividing the partial image data using the defect determination reference value as a threshold, and designating a defect from the divided data.

Thus, since an object shown by partial image data diffuses light in different patterns depending on the illumination environment during image capturing, the contrast ratio of the brightness value between the object indicated by the partial image data and a defect is not constantly fixed. However, as in the present invention, a defect can be more correctly designated from each piece of partial image data captured depending on the illumination environment if the optimum defect determination reference value is obtained based on the partial image data acquired by capturing an image under the illumination environment at the time.

Furthermore, if an illumination is intentionally provided such that the contrast ratio of the brightness value between an object and a defect can be large, it is possible to suppress the influence by a change of disturbance light, thereby furthermore correctly designating the defect.

Thus, according to the present invention, a defect can be automatically detected although an inspection target range exposed to disturbance light is checked.

It is also possible to investigate a defect in a laminating step of laminating prepreg depending on the settings, and an efficient test can be conducted in a shorter time than a visual check. When it is conducted as a temporarily test, and subsequently an operator performs a visual check, the operator can easily find a defect, thereby reducing the load in performing the visual check. Therefore, the number of operators can be reduced, and overlooking defects can be considerably decreased.

The best modes for embodying the present invention are explained below in detail by referring to the attached drawings.

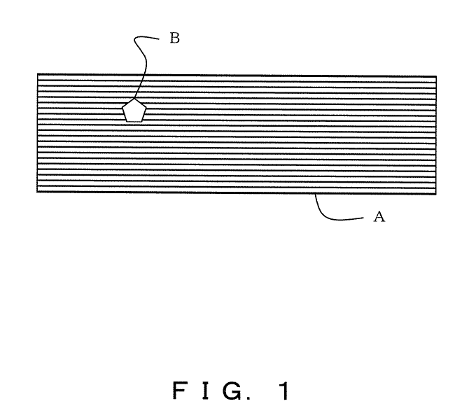

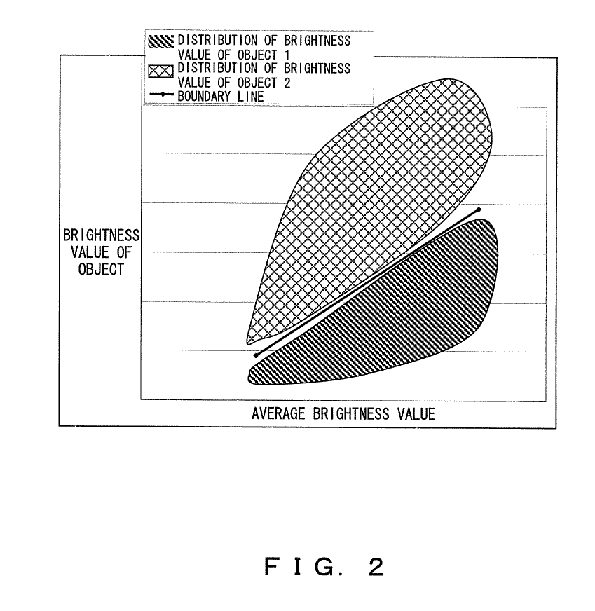

FIGS. 1 and 2 are explanatory views of the method for deriving a defect determination reference value for use in the inspection apparatus according to the present invention.

FIG. 1 shows an image of a mixed object containing two objects. The area filled with the parallel lines indicates an object A, and the white area in the above-mentioned area indicates an object B.

According to an experiment, if the contrast ratio of the brightness value between the object A and the object B is kept equal to or exceeds a predetermined value when the area of the object B in the mixed object is considerably smaller than the area of the object A, the relationship shown in FIG. 2 holds within a certain range of average brightness value. The average brightness value refers to a value obtained by converting the brightness obtained from the entire image or the partial area in the image into a value in a unit area.

FIG. 2 is a graph indicating the correspondence between the average brightness value calculated for the partial area in the image and the brightness value indicated by each object in the partial area.

The graph shows the distribution status of the brightness value of each object using the average brightness value as a horizontal axis and the brightness value of each object as a vertical axis. The distribution status of the brightness value is obtained as a result of repeatedly measuring the average brightness value and the brightness value of each object for any partial area (the size is defined such that the area of the object B is much smaller than that of the object A) in the image in the environment full of disturbance light, and plotting the values. FIG. 2 shows the image of the distribution status.

When the disturbance light on the surface of a mixed object changes during measurement, the level of the brightness value of each object can change although the average brightness value during each measurement is the same. However, although the disturbance light changes, an impossible brightness value for each object within a certain range of average brightness value exists for each average brightness value, and the brightness value is different depending on each average brightness value, when the contrast ratio of the brightness value between objects is maintained at or over a predetermined ratio.

FIG. 2 shows a different pattern of distribution status for each object, and shows the existence of a boundary separating the distribution area of each object almost equally into two portions. The brightness value at the boundary is the impossible brightness value for each object as described above. In FIG. 2, a plurality of values positioned at the boundary are approximated as a straight line to show an example of the shape of the boundary.

In the inspection apparatus according to the present invention, the value around the boundary is used as a defect determination reference value, and is constituted as follows.

The inspection apparatus according to the present invention is constituted to comprise: an image capturing device for capturing an object A's image; and an image data processing device for obtaining a defect determination reference value for each piece of partial image data (image data of the partial area obtained by the image capturing device) indicating a portion of the object A, and detecting the defect (the object B) on the object A in the above partial image data unit based on the defect determination reference value.

In the inspection apparatus with the above-mentioned configuration, although the distribution pattern of the brightness value of image data of the surface of a mixed object and the level of the average brightness value change by the effect of disturbance light, the optimum defect determination reference value can be obtained meeting the change so far as the contrast ratio of the brightness values between objects is equal to or exceeds, thereby detecting a defect from the partial image data.

The application example of the inspection apparatus according to the present invention is shown below.

### Embodiment

In this embodiment, an example of loading the inspection apparatus into a prepreg lamination apparatus (hereinafter referred to simply as a lamination apparatus) for laminating a prepreg material in a mold is explained below.

The inspection apparatus detects a contained foreign object (object B) of a prepreg (the object A) when a prepreg material is applied to a mold.

In the following example, black prepreg using carbon fiber is used as a prepreg material, and a contained foreign object is defined to be a portion having a higher brightness than the prepreg.

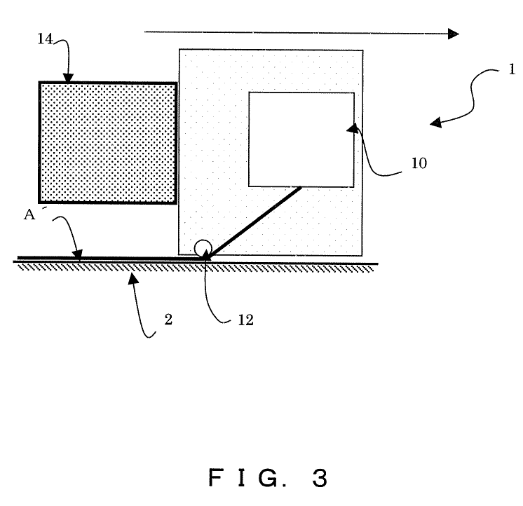

FIG. 3 shows an example of the configuration of the lamination apparatus.

A lamination apparatus 1 shown by FIG. 3 laminates prepreg in the entire area of a mold by moving the lamination apparatus 1 above the mold fixed on the ground.

The lamination apparatus 1 has a configuration of a supply device 10 for providing prepreg A′, a roller 12 for crimping the prepreg A′ to the mold 2, and the inspection apparatus 14 for detecting a foreign object on the prepreg A′, which are constituted as one unit, and the control device not shown in the attached drawings, but is remotely arranged for controlling each component.

The lamination apparatus 1 travels to the right (in the direction indicated by the arrow shown in FIG. 3) above the mold fixed on the ground. Since the conventional mechanism is used for the travel, it is omitted in FIG. 3. When the surface of the mold is flat, and the travel of the lamination apparatus 1 is performed as linear travel along the flat surface, an X-axis rail is provided in the horizontal direction shown in FIG. 3, the upper portion of the lamination apparatus 1 is hung on the rail so that it can slide on the rail, and the lamination apparatus 1 travels along the X-axis rail by the travel device not shown in the attached drawings. When the surface of the mold is curved, a lift device for the lamination apparatus 1 to move up and down in the vertical direction is further provided, and the lamination apparatus is smoothly moved along the curved surface by a combination of horizontal travel and vertical travel.

The supply device 10 supplies the prepreg A′ on the mold. The supply device 10 comprises a prepreg supply drum wound with thin, flat, and unused prepreg A′ and a feed mechanism for externally feeding the prepreg A′. The supply device 10 gradually and externally feeds the unused prepreg A′ according to a lamination start signal described later in accordance with the travel speed of the lamination apparatus 1, and stops the feed of the prepreg A′ according to a lamination start signal described later. The prepreg A′ fed by the supply device 10 is pressed to the mold 2 by the roller 12 having the length equal to or longer than the width of the prepreg A′, and attached from the left to the right shown in FIG. 3 on the mold 2.

The inspection apparatus 14 is an apparatus for detecting a contained foreign object B′ at the top surface of the prepreg A′ immediately after attaching the prepreg A′ to the mold 2. The inspection apparatus 14 is arranged at the rear side (left to the lamination apparatus shown in FIG. 3) in the travel direction of the lamination apparatus 1. The inspection apparatus 14 starts the process according to the lamination start signal described later, outputs the process result (foreign object detection result information described later) according to the lamination stop signal described later to the control device, and stops the process.

The control device controls the travel mechanism not shown in the attached drawings, and controls the travel of the lamination apparatus 1. Upon receipt of a lamination start operation from an operator, the device outputs the lamination start signal (lamination information) to the supply device 10 and the inspection apparatus 14, and controls the travel mechanism such that the lamination apparatus 1 can travel at a predetermined speed along the mold. Upon receipt of a lamination stop operation from an operator, the control device outputs the lamination stop signal (lamination information) to the supply device 10 and the inspection apparatus 14, and stops the travel of the lamination apparatus 1. When the foreign object detection result information is output from the inspection apparatus 14 at the termination of lamination, the information is stored in internal memory.

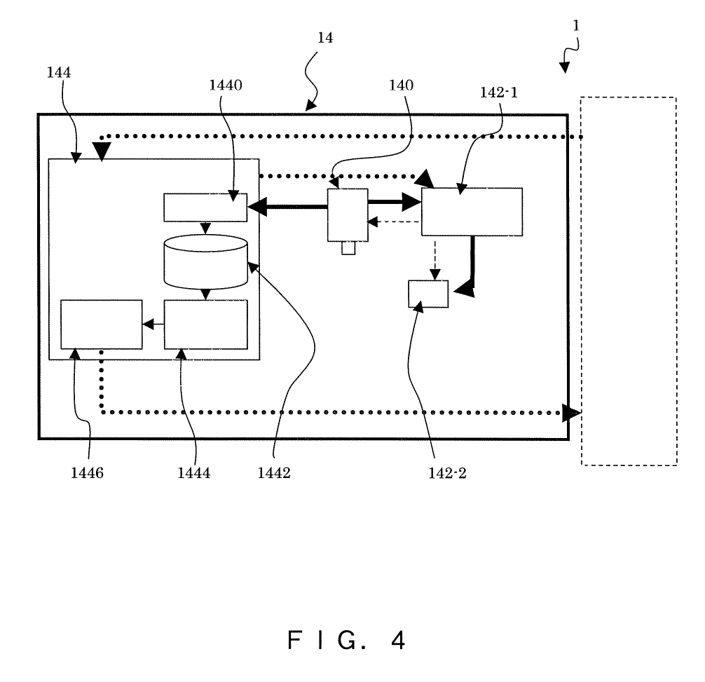

FIG. 4 shows an example of the configuration of the inspection apparatus 14.

The inspection apparatus 14 is provided with an image capturing device 140 (image capturing means), a timing generation device 142-1 and an illumination device 142-2 (illumination means), and an image data processing device 144 (image data processing means).

The image capturing device 140 is constituted by an optical system as a combination of a lens, a band pass filter, etc., a shutter, an optoelectronic transducer such as an image sensor or a line sensor, etc. such as a monochrome CCD (charge coupled device), color CCD, monochrome CMOS, a color CMOS, etc. and a line sensor, a signal processing circuit, etc. for performing various signaling process on the information about a captured image and externally outputting a signal, etc. In the present embodiment, black prepreg is used as a prepreg material. Therefore, the monochrome CCD which is appropriate for finding a contained foreign object in the prepreg is used. However, other optoelectronic transducer means can be used to realize the functions without any restrictions. Describe below are the embodiments using a CCD image sensor for convenience. Since a sensitive unit for detecting the smallest difference in quantity of light is desirable, a higher sensitivity device is selected.

The image capturing device 140 is arranged such that the surface of the prepreg located in the rear (in the direction in which the crimping is completed) of the position (crimping position) where the prepreg is compressed by the roller 12 to the mold 2 becomes an image capturing target. In the present embodiment, the center of the capture range matches the fixed position distant from the above-mentioned pressing position. From this position, an image of the surface (partial area on the surface of the prepreg) of the prepreg in the predetermined range (inspection target range) is captured.

Since the inspection apparatus into which the image capturing device 140 is incorporated travels along the top surface of the mold during lamination, the continuous areas of the surface of the prepreg in the inspection target range (in this range the prepreg is attached on the mold) to which the CCD of the image capturing device 140 is directed are sequentially fed in the direction opposite the travel direction of the inspection apparatus. Considering this, in the image capturing device 140, the shutter timing is set such that the capturing operation can be repeated at the time intervals of catching the entire continuous prepreg surface.

The image capturing device 140 externally outputs a trigger signal for momentarily lighting the illumination device 142-2 at predetermined timing, and externally outputs images out of the inspection target range captured at the set shutter timing as a video signal for each frame.

The timing generation device 142-1 is provided with a circuit for transmitting the lighting timing appropriate for the shutter timing of the CCD camera to the illumination device 142-2. Upon receipt of a lamination start signal, the timing generation device 142-1 provides the internal power for the illumination device or the CCD camera, and then outputs a lighting signal to the illumination device 142-2 at the optimum timing (set depending on, for example, the setting environment, the type of illumination, etc.) based on the trigger signal output from the image capturing device 140.

The illumination device 142-2 is provided with a light emitting device such as a light emission diode, a laser, etc., and a circuit for momentarily lighting them. The illumination device 142-2 momentarily (for the image capturing time by the CCD, etc.) lights the light emitting diode, the laser, etc. according to the lighting signal output from the timing generation device 142-1.

The image data processing device 144 performs the foreign object detecting process according to the video signal output from the monochrome CCD camera 140.

Described below is the timing of each signal (arrow by real bold line/arrow by dotted bold line) of the inspection apparatus.

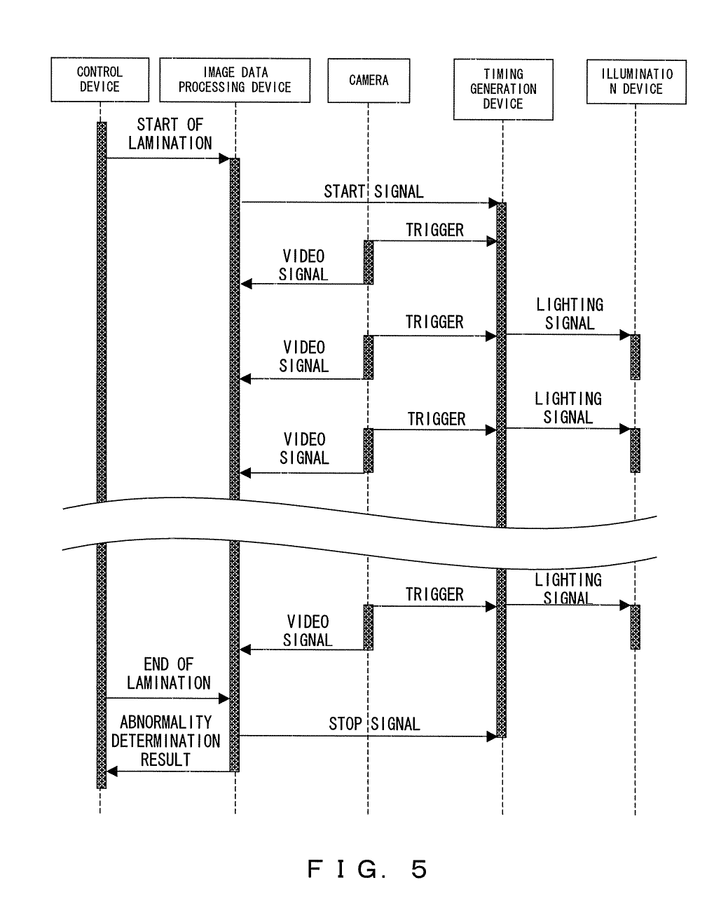

FIG. 5 is a timing chart of the signals.

FIG. 5 shows the timing of the signals transmitted and received between the devices in the inspection apparatus in a series of processes from the start through the stop of the lamination.

First, a lamination start signal is transmitted from the control device to the image data processing device.

Upon receipt of a lamination start signal, the image data processing device transmits the signal to the timing generation device which provides power for the CCD camera and the illumination device, and enters the standby state.

Upon receipt of the provided power, the CCD camera transmits a trigger signal to the timing generation device at predetermined time intervals. After transmitting a trigger signal, the shutter is opened for a predetermined time, and a captured image is transmitted to the image data processing device as a video signal.

Upon receipt of the trigger signal from the CCD camera, the timing generation device transmits a lighting signal to the illumination device after a predetermined time when the shutter is opened next, which is repeated at predetermined time intervals. To allow the period in which the illumination is lighted and the period in which the shutter of the CCD camera is opened match each other, the timing generation device transmits the lighting signal to the illumination device.

The illumination device lights the illumination for a predetermined time after receiving the lighting signal.

When the lamination end signal is transmitted from the control device to the image data processing device, the image data processing device transmits the signal to the timing generation device, and transmits an obtained abnormality determination result information to the control device.

Upon receipt of the lamination end signal, the timing generation device stops supplying power to the illumination device and the CCD camera, and further stops outputting the trigger signal.

Back in FIG. 4, the image data processing device 144 is explained below in detail.

The image data processing device 144 is a circuit provided with a capture unit 1440, a storage unit 1442, a foreign object detection unit 1444, and a result determination unit 1446.

The capture unit 1440 regenerates a video signal output from the monochrome CCD camera 140 as the digital image data (digital partial image data) for each frame. The digital image data is a set data of the brightness value (gray scale value) of each pixel according to the pixel arrangement of the monochrome CCD camera 140, and is output to the storage unit 1442.

The storage unit 1442 is constituted by memory such as RAM (random access memory), etc., stores digital partial image data regenerated by the capture unit 1440, and outputs it to the foreign object detection unit 1444. The memory can be constituted to sequentially store, for example, the digital partial image data of continuous frames (continuous partial image data) in the regeneration order, and sequentially output the data in order starting from the digital partial image data in the first stored frame to the foreign object detection unit 1444.

The foreign object detection unit 1444 is a processing unit for detecting a foreign object in the digital partial image data stored in the storage unit 1442. The processing unit is provided with correspondence information including the average brightness and the foreign object determination reference value having the optimum value variable depending on the value of the average brightness. The processing unit calculates the optimum foreign object determination reference value for the digital partial image data of the storage unit 1442 according to the above-mentioned correspondence information, and performs the process of detecting a foreign object using the optimum foreign object determination reference value. When a foreign object is detected, it outputs a foreign object detection signal to the result determination unit 1446.

The result determination unit 1446 is a processing unit for determining the validity of the detection of a foreign object by the foreign object detection unit 1444. The processing unit determines a foreign object is detected when a foreign object detection signal is received over a plurality of continuous frames (two or more frames) from the foreign object detection unit 1444. If it determines that a foreign object is detected, it notifies the control device that the foreign object has been detected (foreign object detection result information).

The result determination unit 1446 can measure the foreign object detection position based on the lamination start signal (lamination information) transmitted from the control device not shown in the attached drawings. It can be obtained by, for example, counting the elapsed time from the reception of the lamination start signal, and calculating the distance from the lamination start position based on the time from the reception of the lamination start signal to the time of determination of the foreign object and the prepreg supply speed. The obtained foreign object detection position can be transmitted to the control device together with the notification of the detection of the foreign object.

The foreign object detection position can also be measured at the control device side. In case it is measured at the control device side, when the notification that the result determination unit 1446 has detected a foreign object is received, the control device manages the position information adding to the notification.

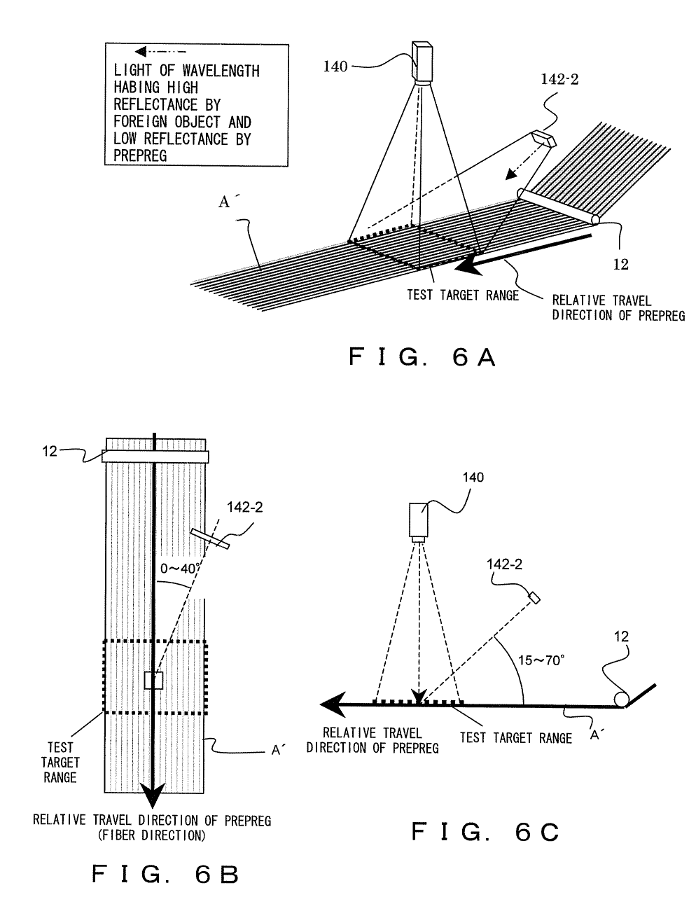

FIG. 6 (6A, 6B, and 6C) is an explanatory view of the configuration of the optimum arrangement when an illumination device is used.

FIG. 6 shows an example of the preferable arrangement of the prepreg A′, the illumination device 142-2 for emitting light to the prepreg A′, and the monochrome CCD camera 140 fixed relating to the predetermined range the prepreg's surface as an image capturing range. In the figures, FIG. 6A is a perspective view of each device when the optimum arrangement is attained, FIG. 6B is a view obtained from above the configuration, and FIG. 6C is a view obtained correctly from the side (from the front side of FIG. 6B) of the configuration. In FIG. 6, the same component as in FIG. 4 is assigned the same reference numeral.

The brightness level of the prepreg area of the image obtained by the monochrome CCD camera 140 greatly depends on the direction of the emission of the illumination onto the surface of the prepreg. For example, when the diffused light of the light emitted to the prepreg from the same distance at the same angle of depression using the same illumination is observed from above the prepreg, the strength of the spread reflected light from the surface of the prepreg is greatly different between when the illumination light is irradiated in the direction orthogonal to the fiber of the prepreg and when the light is irradiated along the direction of the fiber. Practically, when the irradiation direction of the illumination is gradually changed from the direction orthogonal to the fiber direction to the fiber direction, the strength of the diffused reflection light gradually increases as the angle made by the irradiation direction and the fiber direction becomes larger. On the other hand, the strength of the diffused reflection light by the foreign object mixed in the prepreg does not receive almost any influence of the irradiation direction of the illumination (ignorable if any difference detected in strength of the diffused reflection light).

Therefore, if the light is irradiated in the inspection target range from the direction along the fiber direction of the prepreg, the entire brightness level of the prepreg by the spread reflected light of the prepreg can be reduced while maintaining the brightness level of the foreign object, thereby increasing the contrast ratio of the brightness value between the prepreg and the foreign object in the inspection target range.

The configuration of the arrangement in the present embodiment is devised to intentionally increase the contrast ratio of the brightness value between the prepreg and the foreign object in a inspection target range, and more clearly discriminate the prepreg from the foreign object.

First, the configuration of the arrangement of the monochrome CCD camera 140 is explained.

The monochrome CCD camera 140 can be arranged such that acceptable resolution of a inspection target range can be obtained to detect a foreign object. Therefore, according to the present embodiment, the center of the image capturing surface of the camera is positioned on the normal line of the center of the inspection target range set on the surface of the prepreg and set parallel to the prepreg's surface. When there is the possibility that the external illumination can be captured in the prepreg image due to the influence of the external illumination condition, etc., the direction of the camera is changed to the position range in which the necessary resolution can be obtained to detect a foreign object, thereby avoiding the capture of the external illumination. If it is not possible to completely avoid the capture of the external illumination only by changing the direction of a camera, or the necessary resolution cannot be obtained by avoiding the capture, then a shading object is provided to restrict the direct light of the external illumination irradiating the prepreg.

Furthermore, a removal filter such as a band pass filter, etc. for intentionally passing the illumination light (especially the light of a wavelength having a high reflectance by a foreign object) irradiated and removing the light with an another wavelength can be attached in front of the photoreception surface. By attaching the removal filter, the effect of the light of the wavelength other than the wavelength used in detecting a foreign object (especially a disturbing light differs depending on the location of the lamination apparatus or the position on the prepreg) can be ignored, and a more effective process can be expected.

Described next is the configuration of the arrangement of the illumination device 142-2.

FIG. 6B shows the prescription of the rotational angle component in the horizontal direction of light (rotation angle) of the incident light on the surface of the prepreg from the illumination device. As shown in FIG. 6B, it is preferable that the rotational angle of the light irradiated from the illumination device which increases the contrast ratio of the brightness value between the object and the defect is such that the optical axis makes an angle parallel to the fiber direction of the prepreg in a predetermined range (0° through 40° is preferable). FIG. 6C shows the prescription of the rotational angle component (angle of depression) in the direction perpendicular to the incidence angle of the light incident to the surface of the prepreg from the illumination device. As shown in FIG. 6, the angle of depression of the light irradiated from the illumination device which increases the contrast ratio of the brightness value between the object and the defect is such that the optical axis makes an angle in a predetermined range upward to the surface of the prepreg (15° through 70° is preferable).

On the other hand, when the angle is smaller than 15°, there is the possibility that sufficient contrast cannot be obtained due to an insufficient amount of illumination light.

When the surface of the prepreg is not flat and is curved or uneven, a mirrored image of the illumination device can be captured by the CCD under the prescribed illumination condition. Therefore, when the undesired image capturing occurs, the capturing can be avoided by providing a shading object or changing the direction of the CCD camera as explained for the configuration of the arrangement of the CCD camera.

When one CCD camera cannot perform a sufficient process to overcome various curved patterns, a plurality of CCD cameras can be used and arranged by changing the location of the cameras although it is not explained below in detail.

Described below are the types of light for use in the illumination device.

Generally, the types of light used in the illumination device is not restricted to, for example, high-frequency fluorescent light, incandescent light, etc. so far as they cause no trouble in detecting a foreign object. However, if incandescent lamps including a long wavelength are combined when a blue foreign object exists, then the light having a long wavelength indicates a high reflectance on the surface of the prepreg, and a low reflectance on the foreign object. Therefore, the brightness level of the prepreg increases, and the contrast ratio with the brightness value of a foreign object decreases. That is, depending on the combination, the difference in brightness value between the prepreg and the foreign object can be hardly recognized, thereby making the detection of a foreign object more difficult. One of the method of improving the problem is to providing a filter for retrieving a specific wavelength for the CCD camera as described above. Described below is another method of using a specific wavelength light for the ilde.

When a specific wavelength light is used for the illumination device, the light with a wavelength having a high reflectance (higher among the lights with the wavelength having a higher reflectance as compared with the reflectance of the prepreg) by a foreign object is used. In the example where the above-mentioned blue foreign object exists, the illumination light with the blue wavelength band (blue LED or blue laser) is used. By irradiating the light by selecting the wavelength as described above, the contrast ratio of the brightness value between the prepreg and the foreign object can be larger.

However, this method is not limited to a single color, and when there is an object not easily determined on the image screen, the contrast ratio on the screen can be improved by selecting and irradiating the illumination light of a wavelength corresponding to the object to be detected. Although there are a plurality of types of objects to be detected, the contrast ratio can be improved similarly by simultaneously irradiating the illumination light with a plurality of wavelengths.

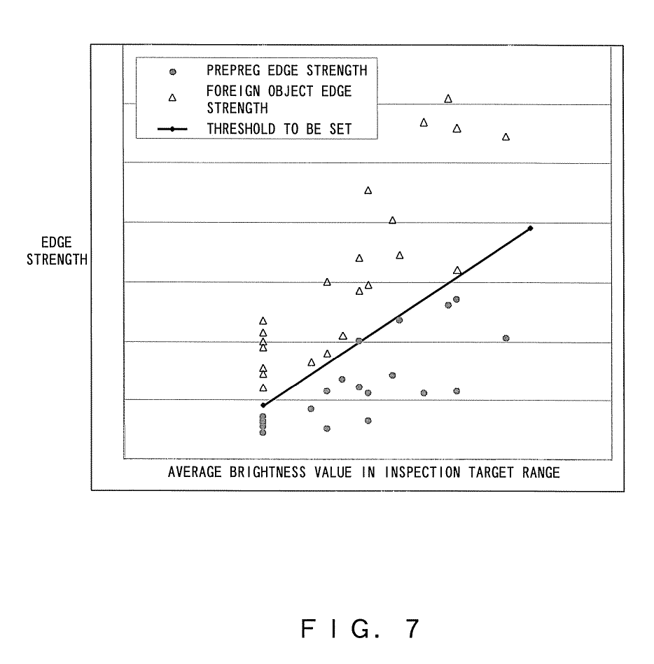

FIG. 7 is a graph of the correspondence information generated with the configuration of the optimum arrangement shown in FIG. 6.

The graph is prepared by plotting the edge strengths of the prepreg and the foreign objects in the inspection target range using the average brightness value as a horizontal axis and the edge brightness value as a vertical axis. Each plot is obtained by measuring the prepreg on which the area of the contained foreign object is very small against the entire area of the prepreg. In the present embodiment, the partial image data is acquired by the CCD camera under various types of external illumination light, and the average brightness value in the partial image data and the edge strengths of the prepreg and the foreign objects in the partial image data are repeatedly measured.

Within the average brightness range shown in FIG. 7, the distribution area of each edge strength is approximately halved by the boundary approximated by a straight line in FIG. 7.

It is preferable that the configuration of the illumination when the correspondence information is generated is the same as the configuration of the illumination of the inspection apparatus.

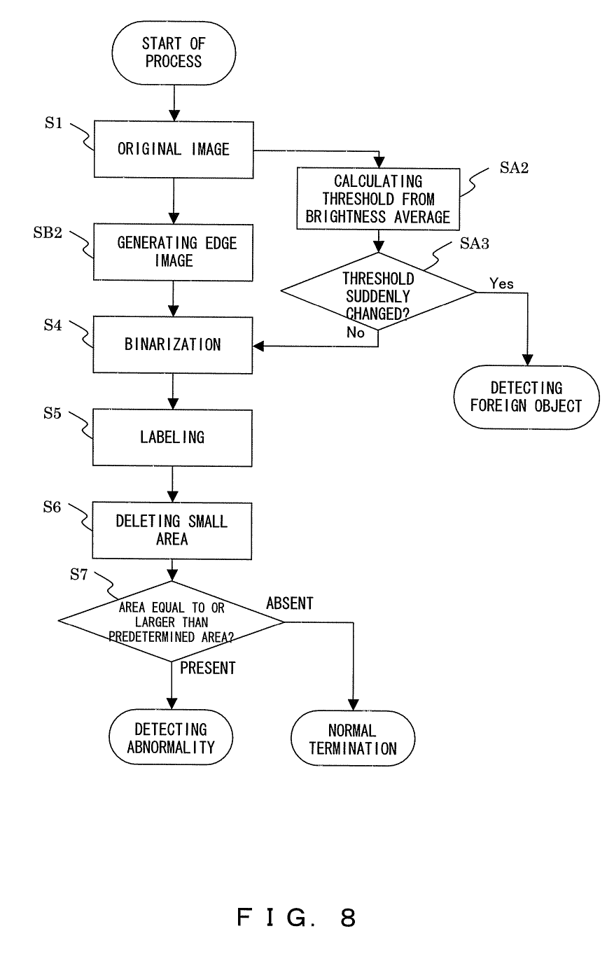

FIG. 8 is a process flow of the foreign object detection unit 1444 of the image data processing device.

In the following description, the foreign object detection unit 1444 is defined as the circuit provided with two arithmetic units and a memory unit such as ROM (read only memory) and RAM, etc., and is connected to the storage unit 1442 and the result determination unit 1446 through a signal line. In the memory unit, for example, the ROM stores various programs used in the above-mentioned process flow and the correspondence information between the average brightness value and the edge strength (hereinafter referred to as a threshold) indicated by a boundary line in FIG. 7, and the RAM is assigned the area in which partial image data output from the storage unit 1442 shown in FIG. 7 is developed, a work area for use in an arithmetic operation, etc., and an area storing the threshold of the first previous partial image data, etc. The various programs used in the above-mentioned process flow are activated immediately after the inspection apparatus receives a lamination start signal, and performs the following process.

First, the partial image data in the storage unit 1442 is developed on the memory (S1). The development of the partial image data is performed in order that the partial image data kept in the storage unit has been stored.

Then, based on the developed partial image data, the processes A and B are concurrently processed.

The process A first obtains the total brightness value of the pixels of the developed partial image data, acquires an average brightness value, and extracts the threshold corresponding to the average brightness value from the correspondence information (SA2).

Then, the difference between the extracted threshold and the threshold extracted from the first previous partial image data is calculated, and the subsequent process is determined depending on the result of the difference (SA3). When the difference is equal to or larger than a predetermined value (indicating a sudden change), the abnormality detection process for the partial image data is terminated (transmitting an instruction to terminate the process following the process B), and control is passed to the process on the next partial image data. Since this case indicates a large foreign object contained in the partial image data, a foreign object detection signal is output to the result determination unit 1446 at this time. Furthermore, in the present embodiment, the threshold extracted from the previous partial image data is overwritten by the threshold out of the current partial image data. When the difference is smaller than a predetermined value, control is passed to the process after the process B.

The predetermined value (indicating a sudden change) can be, for example, the case where the difference exceeds the maximum change amount of the threshold indicated in a predetermined range of the average brightness value. The method of extracting the value is, for example, accomplished by setting in advance a threshold for the difference indicating a sudden change from the threshold in the predetermined range to deal with the average brightness value not contained in the predetermined range.

The process B performs an edge highlighting process on the developed partial image data, and generates edge partial image data (SB2). In the edge highlighting process, the portion indicating a large contrast ratio of the brightness value is extracted by highlighting the edge portion based on the difference result of the brightness values of the adjacent pixels.

In the next process (S4), the results of the processes A and B are used.

In the process (S4), when the difference is smaller than a predetermined value in step SA3, the edge image data is binarized to “0” or “1” based on the threshold (edge strength value) extracted in step SA1, and control is passed to the next process (S5). By the binarizing process, an area containing a foreign object is separated from an area not containing a foreign object. The noise generated in an image generating process can be removed by applying a noise removal filter after the present process. If the difference is equal to or larger than a predetermined value in step SA2, the process is terminated, and control is passed to the process on the subsequent partial image data.

Then, a labeling process is performed based on the binary data (S6). In this process, the area indicated by the binary data having a higher edge strength (for example, “1” out of the above-mentioned “1” and “0”) is labeled, and only that area is extracted. The edge strength when a foreign object exists is generally higher than the edge strength by the coarse surface of the prepreg. However, by increasing the environmental light, higher brightness of an image strengthen the contrast. Therefore, not only the edge strength of a foreign object, but also the edge strength of the surface of the prepreg also tends to increase. Therefore, in this stage, in addition to the area containing a foreign object, a noise by the surface of the prepreg is included.

Therefore, among the above-mentioned labeled areas, small areas are deleted (S7). Thus, the noise portion is removed.

Finally, in the present embodiment, it is determined whether or not there is at least a predetermined size in the remaining labeling area. Only when there is a labeling area having at least a predetermined size, a foreign object detection signal is output to the result determination unit 1446 (S8). The determination is made to recognize an area equal to or larger than a predetermined size as a foreign object. A foreign object smaller than the predetermined area is ignored by determining that a certain quality can be maintained without removing the area from the prepreg.

Then, the abnormality detection process on the partial image data is terminated, and the abnormality detection process on the next partial image data is started. At this time, the threshold extracted for the previous partial image data is updated by the threshold extracted for the current partial image data.

The above-mentioned process can be continued until the lamination end signal is received.

In the inspection apparatus according to the present embodiment, the illumination device is appropriately arranged to intentionally increase the contrast ratio of the brightness value between the prepreg and the foreign object. Therefore, the contrast ratio is maintained at a predetermined ratio or more although the distribution pattern of the brightness value of the image data on the surface of the prepreg and the level of the average brightness value is changed by the effect of the external illumination light etc.,. Then, since the optimum threshold can be used according to the change of an average brightness value, a foreign object can be automatically detected from the prepreg with constantly high precision.

Although a large foreign object, etc. suddenly enters a inspection target area, no erroneous detection occurs, and a foreign object can be automatically detected from prepreg with high accuracy.

Furthermore, depending on the settings, a foreign object inspection can be performed in the laminating process of laminating prepreg, thereby more efficiently making a inspection in shorter time than a visual check. This inspection can be momentarily performed, and later an operator can make a visual check. In this case, an operator can find a foreign object more easily, and the load of the visual check can be reduced. Therefore, the number of operators can be reduced, and overlooking foreign objects can be considerably decreased.

The present invention can be realized in various embodiments by combining any styles of embodiments without deviating from the gist of the spirit or main characteristics. Therefore, the above-mentioned embodiments are exemplified in any points, and are not to be interpreted with restrictions. The scope of the present invention is described in the scope of the claims of the present invention, and is not limited by the specifications. Furthermore, any variation or change belonging to the scope of the claims for the patent totally belongs to the present invention.

What is claimed is:

1. An inspection apparatus, comprising:
an image capturing device capturing an object's image; and
an image data processing device obtaining a defect determination reference value for each piece of partial image data indicating a part of the object, and detecting a foreign object in the object in a partial image data unit based on the defect determination reference value.

2. The apparatus according to claim 1, wherein
the defect determination reference value is obtained based on an average brightness value calculated for each piece of the partial image data and predetermined correspondence information indicating a relationship between the average brightness value and a foreign object determination reference value variable depending on the average brightness value.

3. The apparatus according to claim 2, further comprising
an illumination device increasing a contrast ratio of a brightness value between the object and the foreign object, wherein
the correspondence information is information indicating a relationship between the average brightness value of the object under illumination of the illumination device and the defect determination reference value variable depending on the average brightness value.

4. The apparatus according to claim 3, wherein
the relationship indicated by the correspondence information holds when most of the partial image data is indicated by an object.

5. The apparatus according to claim 4, wherein
the image data processing device obtains each average brightness value of previous partial image data and subsequent partial image data in continuous partial image data of the object; and
the device determines that the foreign object is detected when a change of or more than a predetermined value is detected in an average brightness value or a corresponding foreign object determination reference value between respective partial image data.

6. The apparatus according to claim 3, wherein
illumination light of the illumination device has a wavelength hardly absorbed by the defect and easily absorbed by the object.

7. The apparatus according to claim 3, wherein
when the object is a prepreg made of carbon fiber, the optical axis of the illumination device makes an angle of between 0° and 40° against the prepreg fiber in a horizontal direction and an angle of between 15° and 70° to the above from the surface of the prepreg to increase the contrast ratio of the brightness value between the object and the defect.

8. The apparatus according to claim 6, wherein
when the object is a prepreg made of carbon fiber, the optical axis of the illumination device makes an angle of between 0° and 40° against the prepreg fiber in a horizontal direction and an angle of between 15° and 70° to the above from the surface of the prepreg to increase the contrast ratio of the brightness value between the object and the defect.

9. A lamination device sequentially laminating a prepreg on a set mold with the inspection apparatus according to claim 1 being loaded and moving against the mold.

10. A lamination device sequentially laminating a prepreg on a set mold with the inspection apparatus according to claim 2 being loaded and moving against the mold.

11. A lamination device sequentially laminating a prepreg on a set mold with the inspection apparatus according to claim 3 being loaded and moving against the mold.

12. A lamination device sequentially laminating a prepreg on a set mold with the inspection apparatus according to claim 5 being loaded and moving against the mold.

13. A lamination device sequentially laminating a prepreg on a set mold with the inspection apparatus according to claim 7 being loaded and moving against the mold.

14. An inspection method for automatically detecting a defect from image data obtained by capturing an object's image, comprising:
calculating an average brightness value in a partial image data unit indicating a portion of the object;
extracting a defect determination reference value corresponding to the average brightness value in the partial image data unit from predetermined correspondence information;
dividing the partial image data using the defect determination reference value as a threshold; and
designating a defect from the divided data.

15. The method according to claim 14, comprising:
calculating an average brightness value in a partial image data unit indicating a portion of the object;
extracting edge strength information corresponding to the average brightness value in the partial image data unit from predetermined correspondence information;
generating edge image data formed by edge strength information from the partial image data;
dividing the edge image data using the edge strength information as a threshold; and
designating a defect from the divided data of the edge image data.

16. The method according to claim 15, wherein
each average brightness value of previous partial image data and subsequent partial image data is calculated in continuous partial image data of the object, and when a change of a predetermined value or more is detected between the partial image data in the edge strength information corresponding to the average brightness value, it is determined that there is a defect in the subsequent partial image data.
